(19) United States
(12) Patent Application Publication
(10) Pub. No.: US 2025/0043370 A1
(43) Pub. Date: Feb. 6, 2025

(54) Smelting unit for steel production with a tap weight of between 60 t and 350 t

(71) Applicant: SMS group GmbH, Düsseldorf (DE)

(72) Inventors: Hans-Jürgen ODENTHAL, Mettmann (DE); Andreas SCHÜRING, Mülheim (DE); Peter STARKE, Duisburg (DE); Thomas HENKEL, Duisburg (DE)

(73) Assignee: SMS group GmbH, Düsseldorf (DE)

(21) Appl. No.: 18/718,045

(22) PCT Filed: Nov. 28, 2022
(86) PCT No.: PCT/EP2022/083424

§ 371 Date: Jun. 9, 2024

(30) Foreign Application Priority Data
Dec. 13, 2021 (DE) 10 2021 214 227.3

(51) Int. Cl. C21C 5/35; C21C 5/46; C21C 5/52

(52) U.S. Cl. CPC C21C 5/35; C21C 5/462; C21C 5/5217; C21C 5/5252

(57) ABSTRACT

A smelting unit for steel production with a tap weight of between 60 t and 350 t and a method for operating the same are disclosed. By a top lance that moves during operation of the smelting unit and the coordinated injection of process gases by sidewall injectors and the top lance, the undulations in the surface of the molten bath are reduced. As a result, fewer drops detach from the surface of the molten bath and soiling of the upper receptacle and the exhaust manifold is significantly reduced.

### CROSS-REFERENCE TO RELATED APPLICATION

This application is a national stage application, filed under 35 U.S.C. § 371, of International Patent Application PCT/EP2022/083424, filed on Nov. 28, 2022, which claims the benefit of German Patent Application DE 10 2021 214 227.3, filed on Dec. 13, 2021.

### TECHNICAL FIELD

The disclosure relates to a smelting unit for steel production with a tap weight of between 60 t and 350 t and a method for operating the same.

### BACKGROUND

Steel is usually produced from input materials such as pig iron by removing the excess carbon, adding alloying materials and refining the molten metal (metallurgical work). For this purpose, the liquid pig iron is filled into a converter and then oxygen is blown onto or into the melt by means of a top lance and/or bottom or side-wall nozzles (refining of the melt). Alternatively, DRI iron can also be melted down in an electric arc furnace and such input materials can be used as pig iron melt. The melt is subsequently adjusted to the desired final alloy using alloying agents.

In order to reduce work steps, in particular refilling processes, and the associated material losses, the melting of DRI iron and refining is increasingly being carried out in a smelting unit. A smelting unit that can perform both melting and metallurgical work is known, for example, from publication EP 0 717 115 A1. In a double-receptacle electric arc furnace, electrical energy can be introduced into one of the receptacles by means of the graphite electrodes or switched to an operating state with chemical energy/refining by changing the cover. As a result, the smelting unit is able to produce a metallic melt from solid input materials, change the energy sources required for this and perform metallurgical work.

In the operating state, with which chemical energy is used and metallurgical work is performed, oxygen is blown onto the surface of the molten bath or the hot input materials by means of a blowing lance guided through the cover. The oxygen reacts with the liquid melt or the input materials and releases energy in the process. The oxygen is usually injected at a high pressure or volume flow, in order to achieve good mixing of the reactants.

A similar method is disclosed in the publication DE 101 15 779 A1. In addition to oxygen, an inert gas is injected to improve the mixing of the melt. As a result, the efficiency of the oxygen reaction is increased and the melt is heated more evenly. The oxygen input by means of the top lance is not only used to heat up the melt, but also for targeted decarburization of the melt after completion of the melting process. For this purpose, the amount of oxygen injected into the smelting unit is adapted as a function of the carbon content of the input materials.

The disadvantage of the aforementioned processes is that the high volume flows and the associated impulse of the gas jet during injection cause steel and/or slag to splash in the smelting unit (splashing). For example, the process gas injected through the side wall injector hits the surface of the molten bath at a certain angle and creates an elliptically shaped, oscillating impact cavity. The size and depth of the impact cavity depend on the distance between the side wall injector and the surface of the molten bath, the angle of inclination of the side wall injector and the process gas quantity or the process gas volume flow. At the edges of the impact cavity, individual melt areas or droplets are torn off by shear forces between the process gas jet and the melt, transported with high momentum into the furnace environment and deposited on the furnace walls, on the furnace cover and in the furnace elbow. In doing so, most of the metal droplets are torn off the edge of the impact cavity opposite the side wall injector.

As a result, deposits of slag and metal form inside the furnace and in the furnace elbow, which reduce the cross-section of the furnace elbow, impair the function of mechanical components and reduce the yield; this so-called slagging of the furnace during operation must be avoided.

### SUMMARY

The present application teaches a smelting unit and a method for operating the smelting unit, which produces a metallic melt from solid input materials by means of chemical and electrical energy and performs metallurgical work without splashing and slagging.

The smelting unit has a top lance for injecting a process gas and/or solid material, wherein the top lance can be brought into a working position through an opening in the first cover. During operation of the smelting unit, the top lance can be rotated around the axis of the top lance, on the one hand, and around a vertical axis, on the other hand. The top lance can also be pivoted around a horizontal axis. The operation of the smelting unit comprises both the treatment of a melt in the smelting unit and the sequence of a plurality of melts.

The vertical pivot axis is parallel to the axis of rotation of the top lance and makes it possible for the top lance to move on a circular arc segment around the vertical axis. The horizontal axis lies in a plane that is perpendicular to the axis of rotation of the top lance. Pivoting the top lance around such axis makes it possible to adjust different angles of the top lance with respect to the surface of the molten bath.

The distance between the surface of the molten bath and the top lance tip can be changed. A large number of side wall injectors are arranged radially circumferentially around the upper furnace for injecting a process gas and/or solid material, wherein the side wall injectors can be pivoted horizontally and/or vertically by up to ±5°.

Process gases are gases that undergo a reaction with the input materials, the melt and/or the furnace atmosphere. For example, process gases can be oxygen, nitrogen, CₓH_{y} (for example, methane, ethane, etc.), hydrogen or inert gases. Solids are alloying materials, slag formers and/or solid energy sources. For example, fine-grained coal, lime, chrome ore or similar can be used as solids.

The first working position of the top lance is defined by the fact that a gas jet emerging from the top lance at this position enters the furnace chamber and interacts with the furnace atmosphere or the melt. The movement and/or rotation around one or more axes of the top lance is carried out by means of one or more drives, which are preferably connected to the furnace control system. These can be electric, pneumatic or hydraulic drives.

The tip of the top lance is the region of the top lance that is closest to the surface of the molten bath. In doing so, it is not necessary for an outlet opening for the gas jet to be arranged at this point. Known designs for top lances typically have between 3 and 7 Laval nozzles, wherein the individual Laval nozzle itself is inclined between 7° and 25° with respect to the top lance axis. Multi-hole top lances are also known, for example, from publication DE 20 2007 009 161 U1.

Sidewall injectors make it possible for a gas jet and/or a solid to enter the furnace chamber. These can also be gas mixtures or solid/gas mixtures. The above definitions apply to the possible gases or solids. The pivot capability of up to ±5° of the side wall injectors is based on a central installation position of the respective individual injector. As a result, the alignment of the side wall injector and thus the impact cavity it creates in the surface of the molten bath can be adapted to a small extent to different operating conditions and filling levels in the smelting unit. One possible design of a side wall injector as a burner is disclosed in the publication DE 603 05 321 T2.

Such a smelting unit in conjunction with the method of operation minimizes the shear forces of the gas jets acting on the surface of the melt and thus reduces the number of steel and/or slag droplets formed inside the furnace, on the furnace cover and in the furnace elbow. The possibility of performing metallurgical work or introducing chemical energy into the smelting unit by means of the gases and/or solids is retained.

A gas jet directed at an angle from above onto the edge area of the impact cavity induced by the side wall injector reduces the oscillation width of the impact cavity of the side wall injector and disrupts or prevents and ultimately reduces the tearing off of the metal droplets at the edge of the impact cavity of the side wall injector.

The top lance is preferably designed as a multi-hole top lance and has more than 2 outlet openings, preferably more than 5 outlet openings, for a process gas and/or a solid. An increased number of outlet openings on the top lance makes it possible to influence a larger region of the surface of the molten bath. The number, size and shape of the outlet openings and the inclination of the outlet openings are adapted to the side wall injectors. Outlet openings can, for example, be designed as simple openings in the surface of the top lance. However, a nozzle shape is preferred for the design of an outlet opening. In particular, a Laval nozzle or a Venturi nozzle is preferred for a nozzle shape.

The top lance is preferably rotatable by an angle of at least +/−15°, more preferably at least +/−30°, even more preferably +/−45° around the axis of the top lance. As a result, the point of impact of an asymmetrical gas jet emerging from the top lance on the surface of the molten bath can be adjusted as required. The axis of the top lance is defined by the tip of the top lance and the point at which the top lance passes through the furnace cover.

The top lance can be rotated by an angle of at least +/−15°, preferably at least +/−30°, more preferably +/−45° around the vertical axis. The vertical axis is an axis that is parallel to or congruent with the axis of the top lance. As a result, the top lance can be pivoted in or out with respect to the smelting unit. To a small extent, limited by the opening in the furnace cover, such a pivot movement can be used to adjust the position of the impact point of the gas jet in relation to the impact cavities induced by the side wall injectors.

The top lance is preferably pivotable around the horizontal axis by an angle of at least +/−10°, more preferably at least +/−20°, even more preferably +/−30°. Horizontal axes are axes that lie in a horizontal plane. A rotation of the top lance around such an axis increases the range of movement of the tip of the top lance in the smelting unit. The tip has a particularly large range of movement if the horizontal axes of rotation are in the region of the cover opening.

The top lance preferably has at least one supersonic nozzle. Supersonic nozzles make it possible to apply a high impulse of the gas jet to the surface of the molten bath. Preferably, the volume flow of the process gas flowing through this nozzle can be regulated separately from the volume flows of the other outlet openings. As a result, it is possible to refine the melt in a targeted manner and as required, but also to reduce or increase the impulse input into the melt.

There is preferably at least one outlet opening in the top lance for every three gas jets emerging from one or more side wall injectors. It is even more preferable if there is at least one outlet opening in the top lance for every two gas jets emerging from one or more side wall injectors. It is highly preferable if there is at least one outlet opening in the top lance for each gas jet emerging from a side wall injector. As a result, the impact cavities of one or more side wall injectors can be ideally influenced by a gas jet from the top lance.

The upper furnace preferably has more than 4, more preferably more than 5, even more preferably more than 6, side wall injectors. As the number of sidewall injectors increases, the resulting impact cavity can be better distributed on the surface of the melt and the volume flow through the individual sidewall injector decreases in relation to the total volume flow required for the process.

At least one sidewall injector can preferably be switched between injector mode and burner mode. In the injector mode of the side wall injector, a blowing mode for gases as well as a conveying mode for powdery solids can be carried out by the side wall injector. As a result, a single side wall injector can also be used as a gas burner or solid fuel burner at the start of the melting process, for example.

The top lance and the side wall injectors can preferably be operated simultaneously and with coordinated volume flows for a respective process gas. Coordinated operation comprises manual, semi-manual or automatic coordination and adjusting of all volume flows entering the smelting unit through the top lance or side wall injector. The coordination is preferably carried out by adapting the pressure and/or the volume flow of the process gas for each individual side wall injector or for interconnected side wall injectors and the top lance. In the case of a multi-hole top lance, it is preferable that the gas jets emerging through the respective outlet opening can be operated individually or in groups in a coordinated manner. For this purpose, the pressure present and the volume flow can be adjusted individually or in groups for each outlet opening.

With a total volume flow of process gas required for the process, 50% to 90% of the total volume flow can be introduced by the top lance and 10% to 50% of the total volume flow can be introduced by the side wall injectors. The required total volume flow is defined by the volume flow of process gas required at that moment. The process gas can also consist of a variety of different process gases.

The first furnace cover preferably has a furnace elbow for discharging the exhaust gas produced in the smelting unit with an exhaust gas flow velocity of V_{AG}≤50 m/s at an exhaust gas temperature of T_{AG}≥800° C., wherein the furnace elbow has an average diameter of 1.20 m to 3.50 m. The furnace elbow is preferably inclined with respect to the vertical in a range of up to ±30° and preferably has a flow-through length of ≥2.0 m.

Furthermore, the object of the disclosure is achieved by a method for operating a smelting unit for steel production, in which the following steps are carried out:
a. creating an at least partially liquid bath surface
b. injecting a process gas onto the bath surface by means of the side wall injectors
c. lowering the top lance into a first operating position and injecting a process gas onto the bath surface
d. aligning the top lance by rotating, changing the distance of and/or pivoting the top lance to a second operating position, such that
   the at least one core of the impact cavity that can be produced by the top lance lies between two adjacent impact cavities of the side wall injectors, or
   the at least one core of the impact cavity that can be produced by the top lance lies within the region of one of the impact cavities of the side wall injectors.
e. Adjusting and coordinating the volume flows of the process gases of the side wall injectors and the top lance, such that the total quantity or the total volume flow of the required process gas is applied to the bath surface in order to reduce or avoid splashing.

The core of a single impact cavity is the lowest point in the surface of the molten bath caused by the gas jet. Depending on the operating state, for example the temperature of the molten bath, the shape and size of the impact cavity changes over time. The volume flows are adjusted in a coordinated manner in such a way that the surface movement of the surface of the molten bath and the tearing off of melt droplets from the impact cavity as a result of the shear forces are reduced. As a result, the depth of a single impact cavity is reduced.

The ratio of the volume flows of the process gas from the top lance V_{TL} to two adjacent side wall injectors V_{SI} is preferably between \dot{V}_{TL}/\dot{V}_{SI}≥0.5 und \dot{V}_{TL}/\dot{V}_{SI}≤2.0. In this adjustment range, the undulations of the surface of the molten bath and splashing can be effectively reduced. The steps of the method are preferably carried out in the order a) to e), wherein steps d) and e) preferably are performed out several times. By means of this sequence of steps a) to e), the required top lance position can be adjusted very rapidly. Due to the adapting of the top lance several times and coordinating the volume flows, it is possible to react to different operating states of the smelting unit.

Preferably, the volume flow of the process gas through the side wall injectors (15) is adjusted as a function of the volume flow of the process gas through the top lance (12) and the addition of the volume flows results in the currently required total volume flow. The current total volume flow is the volume flow related to the process point in time or process phase that is required for the metallurgical work at such point in time or phase. In doing so, the total volume flow can also be formed by different gases. This ensures, for example, that the melt is not overoxidized or overheated in relation to the point in time.

### BRIEF DESCRIPTION OF THE DRAWINGS

FIG. 1 shows a smelting unit.

FIG. 2 shows impact cavities of the side wall injectors and impact regions of the top lance.

FIG. 3 shows surface movement of a region in different process states.

FIG. 4 shows a schematic overview of the movement options of the top lance.

FIG. 5 shows different variants for positioning the impact cavities

### DETAILED DESCRIPTION

The invention is described in detail below with reference to the figures. In all figures, the same technical elements are provided with the same reference signs.

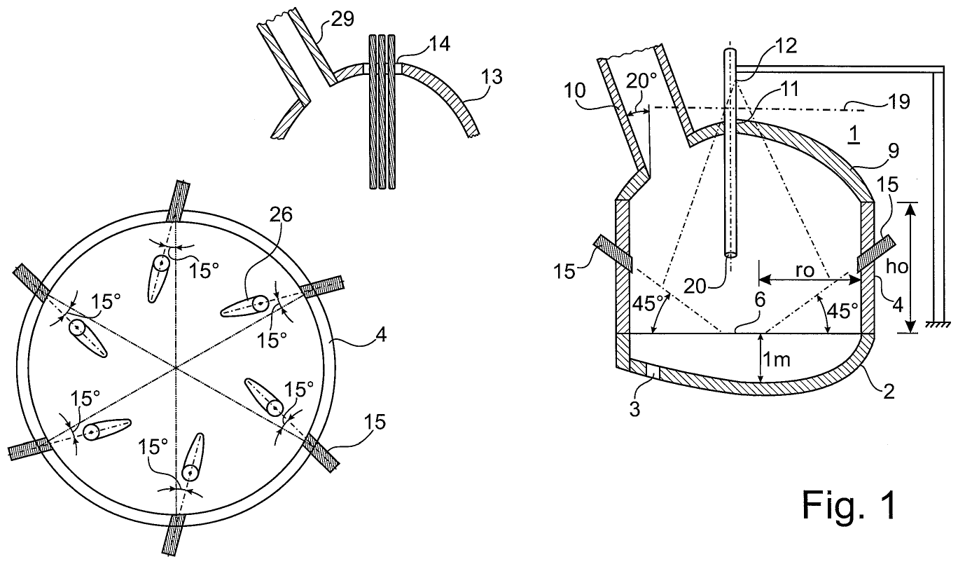

FIG. 1 shows a smelting unit 1. The smelting unit 1 consists of a refractory-lined lower furnace 2 with a tapping hole 3, an upper furnace 4 and two different furnace covers 9, 13. The receptacle bottom 4 of the lower furnace 2 has a “spherical radius” of 10 m, wherein a molten bath height of approximately 1 m is achieved with a melt weight of approximately 90 tons.

The water-cooled upper furnace 8 is substantially designed to be cylindrical in shape and has a height h_{O} of approximately 4.5 m and a radius r_{O} of approximately 3 m. In this example, 6 side wall injectors 15 are arranged circumferentially around the upper furnace 8. The central alignment of the side wall injectors 15 is adjusted in such a way that six impact cavities 26 are formed on a surface 6 of the molten bath. For this purpose, the side wall injectors 15 are inclined by 40° to 50°, preferably by 45°, with respect to the horizontal on the surface 6 of the molten bath. In the lateral direction, the side wall injectors 15 can be inclined by up to 15°. As a result, a counterclockwise circumferential molten bath movement in the melt 7 is induced. Three side wall injectors 15 can be switched from injector mode to burner mode. Three further side wall injectors 15 can inject solids such as coal dust, slag formers and/or alloys by means of a conveying gas.

The cooling of the upper furnace 8 and the refractory lining of the lower furnace 2 are designed for both melting mode and metallurgical mode in relation to cooling capacity and the thickness and type of refractory bricks.

The first cover 9 has an exhaust gas nozzle 10 and an opening 11 for inserting a top lance 12 into the smelting unit 1. The exhaust gas nozzle 10 is inclined by approximately 30° with respect to the vertical. The diameter is 1.45 m and the length is 2.80 m. The second cover 13 has an opening 14 in the center with a roof block for three electrodes 27. The exhaust gas nozzle 29 is smaller in diameter with respect to the exhaust gas nozzle 10 of the first cover 9. The covers 9, 13 can be exchanged during operation of the smelting unit by means of two pivot arms to which the covers 9, 13 are fastened in each case.

A gas station 28 or process gas control 16, not shown here, is connected to the side wall injectors 15 and the top lance 12 and controls the pressure and the volume flow of the process gases. The gas station 28 or process gas control 16 itself is integrated into the control system of the smelting unit 1.

The top lance 12 is attached to a further pivot arm. This can be moved with respect to the cover by means of a variety of hydraulic drives. In this example, the top lance 12 can be rotated by ±45° around its longitudinal axis 17 of the top lance 12. The top lance 12 can be pivoted by ±30° around the horizontal axis 19, wherein the pivot point is located approximately 0.5 m above the cover opening 11. In a working position, the top lance 12 can be pivoted by approximately ±10° around the pivot point of the pivot arm. The tip of the top lance 20 can be brought as close as 0.5 m to the surface 6 of the molten bath by the hydraulic drives. By means of the pivot arm, it also possible to remove the top lance 12 completely from the cover or the smelting unit 1.

The top lance 12 itself has seven outlet openings 21 in the region of the tip 20, wherein six are attached circumferentially around the outer surface. A seventh opening is positioned at the tip of the lance 20; this is in operation when the top lance is inactive in order to prevent the lance from scorching. This seventh opening can be designed as a Venturi nozzle or supersonic nozzle 22. The six outer nozzles are controlled together by the gas station 28 in relation to the pressure and volume flow. The seventh centric nozzle 22 is adjusted separately.

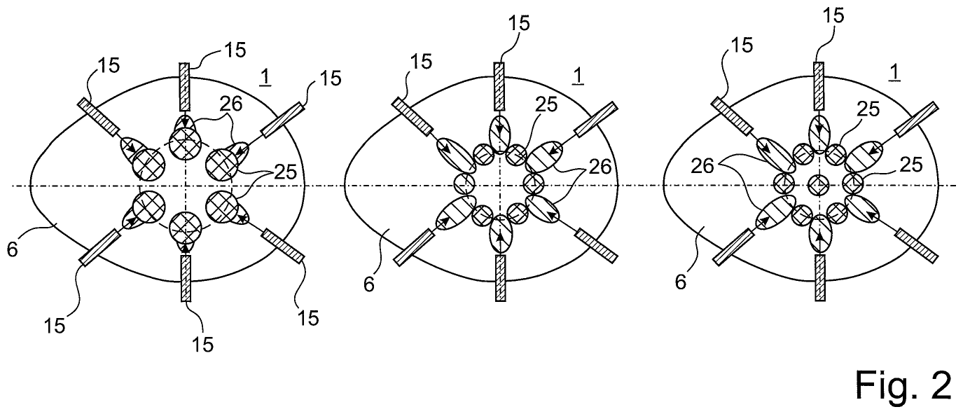

FIG. 2 shows the surface 6 of the molten bath at different points in time of the method. Initially, a metallic melt 7 is produced in the smelting unit 1. On this surface 6 of the molten bath, the side wall injectors 15 produce 6 impact cavities 26 circumferentially, which are approximately oval. The top lance 12 is moved to the first working position 23 and the pressure and volume flow of the six circumferential outlet openings 21 are adjusted. Subsequently, the top lance 12 is then positioned by lowering, rotating and pivoting in such a way that the six impact cavities 25 of the circumferential outlet openings 21 of the top lance 12 in each case touch two adjacent impact cavities 26 of the side wall injectors 15. The volume flow of the Venturi nozzle 22 is subsequently adjusted in such a way that a shallow impact cavity is created in the center of the surface 6 of the molten bath.

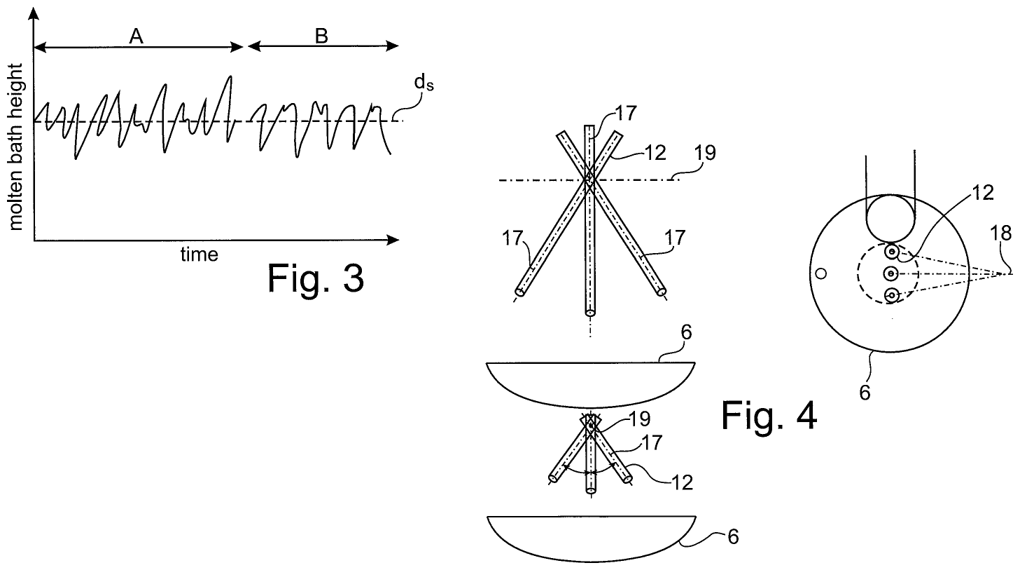

FIG. 3 shows the course over time of the height of the surface of the molten bath (fluctuation value) in the edge region of an impact cavity 26 of a side wall injector 15 along with the time-averaged course of the height of the surface 6 of the molten bath at the edge of a impact cavity 26 of a side wall injector 15. In region A of the diagram, a large movement around the average molten bath height d_{S} of 1 m can be seen. From a deviation of approximately ±0.10 m upwards and downwards, slag and/or steel splashes are formed, which detach from the surface 6 of the molten bath. In region B of the diagram, a gas jet from the top lance 12 acts on this region. As a result, the fluctuation range of the melt pool height d_{S} is reduced by approximately 50%.

FIG. 4 shows by way of example the different pivot and rotation options of the top lance 12 in relation to the surface 6 of the molten bath and different axes 17, 18, 19. Possible movements are indicated schematically by the arrows.

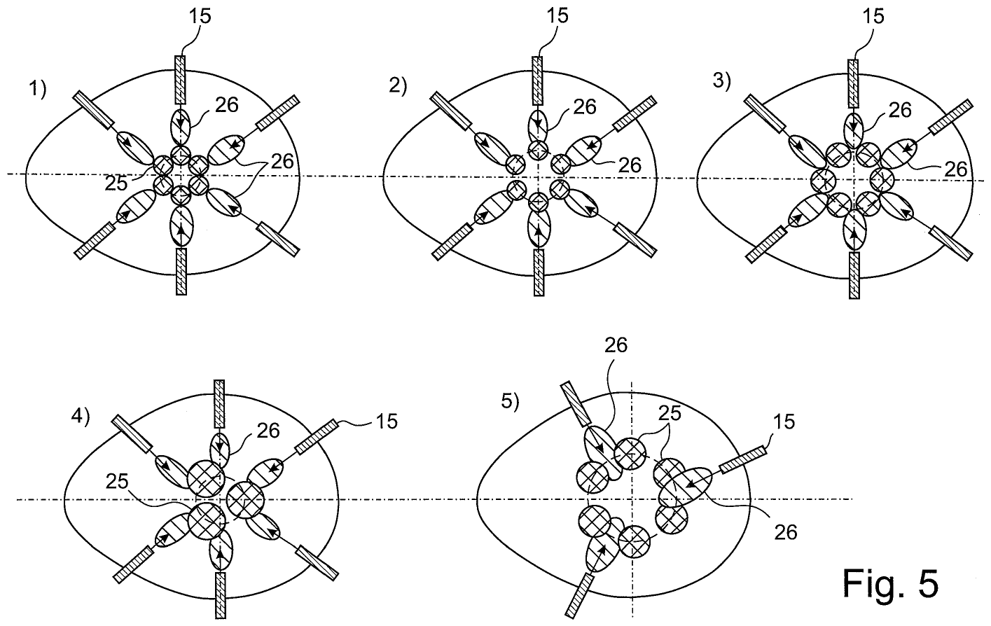

FIG. 5 shows in illustrations 1) to 5) different variants of the positioning of the impact cavities in relation to one another. Illustration 1) shows six impact cavities of the side wall injectors on the surface of the molten bath. The six impact cavities of the top lance are positioned such that one of the impact cavities of the top lance is in contact with one impact cavity of a side wall injector in each case. The contact point of the two impact cavities is on the side of the impact cavity facing away from the side wall injector.

In Illustration 2), the impact cavities of the top lance are larger with respect to the impact cavities of the top lance shown in Illustration 1). Furthermore, the impact cavities of the top lance are pushed outwards and cover a part of the impact cavities of the side wall injectors. A change in the positioning of the impact cavities of the top lances from Illustration 1) to 2) can be carried out, for example, by increasing the distance between the top lance and the surface of the molten bath.

In Illustration 3), the impact cavities of the top lance are positioned in such a way that one impact cavity of the top lance is in contact with in each case two impact cavities of two side wall injectors or partially covers them. Such a positioning can be achieved, for example, by rotating the top lance around the axis of the top lance from a positioning as shown in Illustration 2).

Illustration 4) shows an arrangement of impact cavities with a three-hole blowing lance. In the case shown, one impact cavity of the top lance covers partial regions of two adjacent impact cavities of the side wall injectors. In contrast, in Illustration 5) three side wall injectors are arranged or active in the smelting unit. The impact cavities of the six-hole top lance are positioned in such a way that in each case two of the impact cavities touch or overlap an impact cavity of a side wall injector.

| Reference sign | Designatum |
|---|---|
| 1 | Smelting unit |
| 2 | Lower furnace |
| 3 | Tapping hole |
| 4 | Receptacle bottom |
| 6 | Surface of the molten bath |
| 7 | Melt |
| 8 | Upper furnace |
| 9 | First cover |
| 10 | Exhaust gas nozzle |
| 11 | Opening |
| 12 | Top lance |
| 13 | Second cover |
| 14 | Opening |
| 15 | Sidewall injectors |
| 16 | Process gas control |
| 17 | Axis of the top lance |
| 18 | Vertical axis |
| 19 | Horizontal axis |
| 20 | Top lance tip |
| 21 | Outlet opening |
| 22 | Supersonic nozzle |
| 23 | First working position |
| 24 | Second working position |
| 25 | Impact cavity of top lance |
| 26 | Impact cavity of side wall injector |
| 27 | Electrode |
| 28 | Gas station |
| d_{S} | Distance between receptacle bottom and |
| | surface of the molten bath |
| h_{S} | Distance of tip of top lance - surface of the |
| | molten bath |
| h_{O} | Height of upper furnace |
| r_{O} | Radius of upper furnace |
| V_{AG} | Exhaust gas velocity |
| T_{AG} | Exhaust gas temperature |

1.-17. (canceled)

18. A smelting unit (1) for steel production with a tap weight between 60 t and 350 t, comprising:
a lower furnace (2),
wherein the lower furnace (2) is refractory-lined and includes a tapping hole (3),
wherein a receptacle bottom (4) of the lower furnace (2) substantially corresponds to a spherically shaped shell section,
wherein a sphere from which the spherically shaped shell section originates geometrically has a radius≥5 m and ≤15 m, and
wherein a distance (d_{S}) between a lowest point of the receptacle bottom (4) in the lower furnace (2) and a surface (6) of a melt (7) located therein in an operating state is ≥0.5 m and ≤1.5 m;
an upper furnace (8),
wherein the upper furnace (8) is substantially cylindrical and water-cooled, and
wherein a height (h_{O}) of the upper furnace (8) is ≥3 m and a radius (r_{O}) of the upper furnace (8) is ≥2 m;
a first cover (9) closing the upper furnace (8) at a top, having an exhaust gas nozzle (10) and at least one opening (11) for inserting a top lance (12) into the smelting unit (1)
wherein the top lance (12) can be brought into a working position through the opening (11) in the first cover (9), and
wherein the top lance (12) is rotatable around a longitudinal axis (17) of the top lance (12), is rotatable around a vertical axis (18), and/or is pivotable around a horizontal axis (19) during operation of the smelting unit (1), and
wherein a distance (h_{S}) between the surface (6) of the melt (7) and a tip (20) of the top lance (12) can be varied;
a second cover (13) closing the upper furnace (8) at the top, having at least one opening (14) for passage of one or more electrodes (27),
wherein the lower furnace (2) and the upper furnace (8) are designed for operation both with and without a melt current, and
wherein the first cover (9) can be exchanged for the second cover (13) during operation of the smelting unit (1);
a plurality of side wall injectors (15) arranged radially circumferentially in the upper furnace (8) for injecting a process gas,
wherein the side wall injectors (15) can be pivoted horizontally and/or vertically by up to ±5°; and
a process gas control (16) for adjusting a pressure and/or a volume flow of the process gas for the top lance (12) and the side wall injectors (15).

19. The smelting unit according to claim 18,
wherein the top lance (12) is a multi-hole top lance, and
wherein the top lance (12) has more than 5 outlet openings (21) for the process gas.

20. The smelting unit according to claim 18,
wherein the top lance (12) can be rotated by an angle of +/−45° around the longitudinal axis (17) of the top lance (12).

21. The smelting unit according to claim 18,
wherein the top lance (12) can be rotated by an angle of +/−45° around the vertical axis (18) in the working position.

22. The smelting unit according to claim 18,
wherein the top lance (12) can be pivoted by an angle of +/−30° around the horizontal axis (20).

23. The smelting unit according to claim 18,
wherein the top lance (12) has at least one supersonic nozzle (22).

24. The smelting unit according to claim 18,
wherein at least one outlet opening (21) is present in the top lance (12) for each gas jet emerging from a side wall injector (15).

25. The smelting unit according to claim 18,
wherein the upper furnace (8) has more than six side wall injectors (15).

26. The smelting unit according to claim 18,
wherein at least one side wall injector (15) can be switched between a burner mode and a blowing mode.

27. The smelting unit according to claim 18,
wherein the top lance (12) and the side wall injectors (15) can be operated simultaneously and with coordinated volume flows for the process gas by a common gas station (22) or the process gas control (16).

28. The smelting unit according to claim 18,
wherein 50% to 90% of a total volume flow of the process gas can be introduced through the top lance (12) and 10% to 50% of the total volume flow can be introduced through the side wall injectors (15).

29. The smelting unit according to claim 18,
wherein the exhaust gas nozzle (10) is configured for discharging exhaust gas produced in the smelting unit at an exhaust gas flow velocity of V_{AG}≤50 m/s at an exhaust gas temperature of T_{AG}≥800° C., and
wherein the exhaust gas nozzle (10) has an average diameter of 1.20 m to 3.5 m, and
wherein the exhaust gas nozzle (10) is inclined with respect to the vertical axis in a range of +30° and has a flow-through length (I_{A}) of ≥2.0 m.

30. A method, comprising:
providing smelting unit (1) for steel production with a tap weight between 60 t and 350 t, including
a lower furnace (2),
wherein the lower furnace (2) is refractory-lined and includes a tapping hole (3),
wherein a receptacle bottom (4) of the lower furnace (2) substantially corresponds to a spherically shaped shell section and
wherein a sphere from which the spherically shaped shell section originates geometrically has a radius≥5 m and ≤15 m, and
wherein a distance (d_{S}) between a lowest point of the receptacle bottom (4) in the lower furnace (2) and a surface (6) of a melt (7) located therein in an operating state is ≥0.5 m and ≤1.5 m;
an upper furnace (8),
wherein the upper furnace (8) is substantially cylindrical and water-cooled, and
wherein a height (h_{O}) of the upper furnace (8) is ≥3 m and a radius (r_{O}) of the upper furnace (8) is ≥2 m;
a first cover (9) closing the upper furnace (8) at a top, having an exhaust gas nozzle (10) and at least one opening (11) for inserting a top lance (12) into the smelting unit (1)
wherein the top lance (12) can be brought into a working position through the opening (11) in the first cover (9), and
wherein the top lance (12) is rotatable around a longitudinal axis (17) of the top lance (12), is rotatable around a vertical axis (18), and/or is pivotable around a horizontal axis (19) during operation of the smelting unit (1), and
wherein a distance (h_{S}) between the surface (6) of the melt (7) and a tip (20) of the top lance (12) can be varied;
a second cover (13) closing the upper furnace (8) at the top, having at least one opening (14) for passage of one or more electrodes (27),
wherein the lower furnace (2) and the upper furnace (8) are designed for operation both with and without a melt current, and
wherein the first cover (9) can be exchanged for the second cover (13) during operation of the smelting unit (1);
a plurality of side wall injectors (15) arranged radially circumferentially in the upper furnace (8) for injecting a process gas,
wherein the side wall injectors (15) can be pivoted horizontally and/or vertically by up to +5°; and
a process gas control (16) for adjusting a pressure and/or a volume flow of the process gas for the top lance (12) and the side wall injectors (15); and
operating the smelting unit by performing the following steps:
a) creating the melt (7) having the surface (6);
b) injecting the process gas onto the surface (6) by the side wall injectors (15);
c) lowering the top lance (12) into a first working position (23) and injecting the process gas onto the surface (6) through the top lance (12);
d) aligning the top lance (12) by rotating, changing the distance (h_{S}), and/or pivoting the top lance (12) to a second working position (24), such that
a core of an impact cavity (25) produced by the top lance (12) lies between two adjacent impact cavities (26) of the side wall injectors (15), or
the core of the impact cavity (25) produced by the top lance (15) lies within a region of one of impact cavities (26) of the side wall injectors (15);
e) adjusting volume flows of the process gas of the side wall injectors (15) and the top lance (12), such that a total required quantity or a total required volume flow of the process gas is applied to the surface (6).

31. The method according to claim 30,
wherein a ratio of the volume flows of the process gas from the top lance (12) to two adjacent side wall injectors (15) is \dot{V}_{TL}/\dot{V}_{SI}≥0.5 and \dot{V}_{TL}/\dot{V}_{SI}≤2.0.

32. The method according to claim 30,
wherein the steps are carried out in order a) to e).

33. The method according to claim 30,
wherein the steps d) and e) are performed several times.

34. The method according to claim 30, further comprising
adjusting the volume flow of the process gas through the side wall injectors (15) as a function of the volume flow of the process gas through the top lance (12).
